(19) United States
(12) Patent Application Publication
(10) Pub. No.: US 2026/0217491 A1
(43) Pub. Date: Jul. 30, 2026

(54) APPLICATION DEVICE HAVING AN OSCILLATING DISPENSING EDGE AND A CARTRIDGE DEVICE, CARTRIDGE DEVICE, BASE DEVICE, ROBOT DEVICE AND MANUFACTURING SYSTEM

(71) Applicant: tesa SE, Norderstedt (DE)

(72) Inventors: Deniz Nick Akin, Hamburg (DE); Marten Rohde, Bienenbüttel (DE)

(73) Assignee: tesa SE, Norderstedt (DE)

(21) Appl. No.: 18/577,605

(22) PCT Filed: Jul. 8, 2022
(86) PCT No.: PCT/EP2022/069077

§ 371 Date: Jan. 8, 2024

(30) Foreign Application Priority Data
Jul. 9, 2021 (DE) 10 2021 207 282.8

(51) Int. Cl. B65H 35/00; B65H 19/12; B65H 75/18

(52) U.S. Cl. CPC B65H 35/0013; B65H 19/12; B65H 35/0073; B65H 75/182; B65H 2301/4193; B65H 2301/5163; B65H 2404/10; B65H 2406/342; B65H 2701/194

(57) ABSTRACT

An application device includes: a cassette device and a base device. The cassette device has a housing with a first opening that can accommodate a tape being guided along a path; and a guide unit arranged in the housing configured to guide the tape such that a first side of the tape faces the first opening in the first section of the path. The base device comprises a main body and a deflection unit having a deflection element, arranged on a second side of the tape, and opposite the first section of the path. The deflection unit is coupled to the main body such that it can be moved between retracted and extended positions. In the retracted position, the deflection element and the tape are in the interior. In the extended position, a portion of the tape bears against the deflection element.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/EP2022/069077, filed on Jul. 8, 2022, designating the United States of America, which in turn claims the benefit of priority under 35 U.S.C. § § 119, 365 of German Patent Application No. 102021207282.8, filed Jul. 9, 2021, the contents of which are relied upon and incorporated herein by reference in their entirety.

### FIELD OF THE DISCLOSURE

The present invention relates to an application device, a cassette device, a base device, a robot device and a manufacturing system.

### BACKGROUND

Application devices are known from the prior art. For example, application devices can provide self-adhesive punched parts in order to apply them to a workpiece. The self-adhesive punched parts are often provided with the aid of a tape on which the self-adhesive punched parts are arranged. The self-adhesive punched parts can comprise a pressure-sensitive adhesive surface with which the self-adhesive punched parts are attached to the tape, detached from the tape and subsequently applied to the workpiece in such a manner that the self-adhesive punched parts are bonded to the workpiece by means of their pressure-sensitive adhesive surface.

In general, it is desirable to provide application devices with which the self-adhesive punched parts can be provided in a simple and quick manner. Furthermore, it is desirable that the application devices are designed in such a manner that the self-adhesive punched parts are protected from environmental influences, in particular before they are applied to a workpiece.

It is therefore the object of the present invention to provide an application device with which self-adhesive punched parts can be provided in a simple and quick manner and the self-adhesive punched parts can be protected from environmental influences.

### BRIEF SUMMARY OF THE DISCLOSURE

In accordance with a first aspect of the invention, the object mentioned is achieved by an application device. The application device comprises a cassette device and a base device. The cassette device comprises a housing having a first connecting device. A first opening is formed in the housing. The opening connects an interior space of the housing to an external environment of the housing. A tape is accommodated in the interior space. The tape extends from a first end to a second end. Self-adhesive punched parts are arranged on a first side of the tape. The cassette device comprises a first reel which is arranged in the interior space of the housing and is mounted on the housing so as to be able to rotate about a first axis of rotation and comprises a first reel core. The tape is wound around the first reel core with a section which comprises the first end. The cassette device comprises a second reel which is arranged in the interior space of the housing and is mounted on the housing so as to be able to rotate about a second axis of rotation and comprises a second reel core. A section of the tape which comprises the second end is attached to the second reel core. The tape is guided along a path from the first reel to the second reel. The cassette device comprises a guide unit which is arranged in the interior space of the housing and is connected to the housing. The guide unit is designed in such a manner that the tape is guided on the guide unit in such a manner that a first section of the path is opposite the first opening. In the region of the first section, the first side of the tape faces the first opening.

The base device comprises a base body having a second connecting device which is connected in a positive-locking and releasable manner to the first connecting device, and a third connecting device for connection to a manufacturing system. The base device comprises a deflection unit which is arranged at least in sections in the interior space of the housing and comprises a deflection element which is attached to a free end. The deflection element is arranged on a second side of the tape which is opposite the first side of the tape and opposite the first section. The deflection unit is movably coupled to the base body in such a manner that the deflection unit can be moved between a retracted position and an extended position. In the retracted position, the deflection element and the tape are arranged in the interior space. In the extended position, a subsection of the tape is in contact with the deflection element, and the deflection element and at least the subsection of the tape which is in contact with the deflection element are arranged in the external environment.

In accordance with a second aspect of the invention, the object mentioned above is achieved by a cassette device. The cassette device is designed for an application device according to the first aspect. The cassette device comprises a housing having a first connecting device. The first connecting device is designed in such a manner that it can be connected in a positive-locking and releasable manner to a second connecting device of a base body of a base device. A first opening is formed in the housing. The opening connects an interior space of the housing to an external environment of the housing. A tape is accommodated in the interior space. The tape extends from a first end to a second end. Self-adhesive punched parts are arranged on a first side of the tape. The cassette device comprises a first reel which is arranged in the interior space of the housing and is mounted on the housing so as to be able to rotate about a first axis of rotation and comprises a first reel core. The tape is wound around the first reel core with a section which comprises the first end. The cassette device comprises a second reel which is arranged in the interior space of the housing and is mounted on the housing so as to be able to rotate about a second axis of rotation and comprises a second reel core. A section of the tape which comprises the second end is attached to the second reel core. The tape is guided along a path from the first reel to the second reel. The cassette device comprises a guide unit which is arranged in the interior space of the housing and is connected to the housing. The guide unit is designed in such a manner that the tape is guided on the guide unit in such a manner that a first section of the path is opposite the first opening. In the region of the first section, the first side of the tape faces the first opening. The features, technical effects and/or advantages which are described in connection with the application device according to the first aspect of the invention also apply at least in an analogous manner to the cassette device according to the second aspect of the invention, so that a corresponding repetition is dispensed with at this point.

In accordance with a third aspect of the invention, the object mentioned above is achieved by a base device. The base device comprises a base body and a third connecting device. The base body comprises a second connecting device which can be connected in a positive-locking and releasable manner to a first connecting device of a housing of a cassette device according to the second aspect. The third connecting device is designed for connection to a manufacturing system. The base device comprises a deflection unit having a deflection element which is attached to a free end. The deflection unit is movably coupled to the base body in such a manner that the deflection unit can be moved between a retracted position and an extended position. Then, when the first connecting device and the second connecting device are connected in a positive-locking and releasable manner to one another, the deflection unit is arranged at least in sections in the interior space of the housing, the deflection element is arranged on a second side of the tape which is opposite the first side of the tape and opposite the first section of the path, and in the retracted position the deflection element and the tape are arranged in the interior space, and in the extended position a subsection of the tape is in contact with the deflection element, and the deflection element and at least the subsection of the tape which is in contact with the deflection element are arranged in the external environment. The features, technical effects and/or advantages which are described in connection with the application device according to the first aspect of the invention and in connection with the cassette device according to the second aspect of the invention also apply at least in an analogous manner to the base device according to the third aspect of the invention, so that a corresponding repetition is dispensed with at this point.

In accordance with a fourth aspect of the invention, the object mentioned above is achieved by a robot device. The robot device comprises a frame and a robotic arm. The robotic arm is attached with its first end to the frame and is attached with its second end to the third connecting device of the base device according to the third aspect. The features, technical effects and/or advantages which are described in connection with the application device according to the first aspect of the invention, in connection with the cassette device according to the second aspect of the invention and in connection with the base device according to the third aspect of the invention also apply at least in an analogous manner to the robot device according to the fourth aspect of the invention, so that a corresponding repetition is dispensed with at this point.

In accordance with a fifth aspect of the invention, the object mentioned above is achieved by a manufacturing system. The manufacturing system comprises a robot device according to the fourth aspect and a changing station in which a plurality of cassette devices according to the second aspect are arranged. The plurality of cassette devices in the changing station ensures that a plurality of punched parts can be applied to a workpiece. In particular, it is provided that, with the aid of the changing station, the plurality of cassette devices can be used in succession to provide a plurality of punched parts. This can be made possible by moving the base device to the changing station, detaching a first cassette device from the base device, depositing the first cassette device in the changing station, picking up a second cassette device from the changing station and attaching the second cassette device to the base device.

Further advantages, features and possible applications of the present invention are disclosed below in the description of the exemplary embodiments and the figures. All of the features described and/or illustrated form the subject matter of the invention in themselves and in any combination, irrespective of their composition in the individual claims or their references. In the figures, identical reference signs also stand for identical or similar objects.

### BRIEF DESCRIPTION OF DRAWINGS

FIG. 1 shows a schematic view of an embodiment of an application device according to the invention, wherein a deflection unit is arranged in a retracted position and a piston is arranged in a first position;

FIG. 2 shows a schematic view of an embodiment of a cassette device according to the invention of the application device in FIG. 1;

FIG. 3 shows a schematic view of an embodiment of a base device according to the invention of the application device in FIG. 1;

FIG. 4 shows the application device in FIG. 1, wherein the deflection unit is arranged in an extended position and the piston is arranged in the first position;

FIG. 5 shows the application device in FIG. 1, wherein the deflection unit is arranged in an intermediate position and the piston is arranged in a second position; and

FIG. 6 shows the application device in FIG. 1, wherein the deflection unit is arranged in the intermediate position and the piston is arranged in a third position.

### DETAILED DESCRIPTION

The application device comprises a cassette device and a base device. The cassette device forms a section of the application device. The base device also forms a section of the application device.

The cassette device comprises a housing having the first connecting device. The housing can comprise a wall with an inner surface that faces the interior space. Furthermore, the wall can comprise an outer surface which faces the external environment. The housing and in particular the wall of the housing can separate the interior space and the external environment from one another and can thereby prevent contamination of the interior space and of elements which are arranged in the interior space. For example, contamination of the self-adhesive punched parts can be prevented by the housing. In particular, the self-adhesive punched parts can be protected from environmental influences, especially before they are applied to a workpiece. The housing comprises the first connecting device. The first connecting device is designed so as to be connected in a positive-locking and releasable manner to the second connecting device.

The first opening is formed in the housing. The first opening connects an interior space of the housing to an external environment of the housing. By virtue of the fact that the first opening connects the interior space of the housing to the external environment of the housing, the first opening enables an element of the application device, such as the deflection unit, to be arranged in such a manner that the element extends through the first opening and at least a section of the element is arranged in the interior space and a section of the element is arranged in the external environment. The interior space of the housing may be considered to be the space surrounded by the housing. An element which is located in the interior space of the housing can be considered to be enclosed by the housing. For example, an element that is accommodated in the interior space of the housing is arranged in the interior space of the housing. The external environment of the housing can be regarded as the space that is not surrounded by the housing. An element that is arranged in the external environment of the housing can be regarded as not being enclosed by the housing or as being arranged outside the housing.

A tape is accommodated in the interior space. The tape is therefore arranged in the interior space. By virtue of the fact that the tape is accommodated in the interior space, the tape can be protected from environmental influences. In particular, contamination of the tape can be prevented by the housing. The tape extends from a first end to a second end. The tape can be rolled up at least in sections and can extend between rolled-up sections along one or multiple non-rolled-up sections along a corresponding straight line or plane.

The self-adhesive punched parts are arranged on the first side of the tape. The self-adhesive punched parts can comprise a pressure-sensitive adhesive surface. The pressure-sensitive adhesive surface can be used to attach the self-adhesive punched parts to the tape. The self-adhesive punched parts can be detached from the tape and then applied to a workpiece in such a manner that the self-adhesive punched parts are bonded to the workpiece by means of their pressure-sensitive adhesive surface. The self-adhesive punched parts are arranged on the first side of the tape.

The cassette device comprises the first reel which is arranged in the interior space of the housing and is mounted on the housing so as to be able to rotate about a first axis of rotation and comprises the first reel core. The first reel is arranged in the interior space of the housing. By virtue of the fact that the first reel is arranged in the interior space of the housing, the first reel can be protected from environmental influences. In particular, contamination of the first reel can be prevented by the housing. The first reel is mounted on the housing so as to be able to rotate about the first axis of rotation. By virtue of the rotatable mounting of the first reel, the tape can be wound on and from the first reel by rotating the first reel about the first reel. In particular, it is provided that the tape is wound around the first reel core with a section and, by rotating the first reel, this section of the tape can be unwound at least in sections from the first reel in order to provide the self-adhesive punched parts.

The tape is wound around the first reel core with a section which comprises the first end. In particular, it is provided that the tape is wound around the first reel core with a section which comprises the section which comprises the first end of the tape and, by rotating the first reel, this section of the tape can be unwound at least in sections from the first reel in order to provide the self-adhesive punched parts. It is preferred that, when a large portion of the tape is unwound from the first reel, the section which comprises the first end is wound at least in sections around the first reel core. In particular, it is provided that, when the tape has been unwound from the first reel and all self-adhesive punched parts have been provided, the section which comprises the first end is attached to the first reel core.

The cassette device comprises a second reel arranged in the interior space of the housing and is mounted on the housing so as to be able to rotate about a second axis of rotation and comprises a second reel core. The second reel is arranged in the interior space of the housing. By virtue of the fact that the second reel is arranged in the interior space of the housing, the second reel can be protected from environmental influences. In particular, contamination of the second reel can be prevented by the housing. The second reel is mounted on the housing in such a manner so as to be able to rotate about the second axis of rotation. By virtue of the rotatable mounting of the second reel, the tape can be unwound on and from the second reel by rotating the second reel about the second reel. In particular, it is provided that the tape is wound with a section around the second reel core and, by rotating the second reel, this section of the tape can be wound at least in sections onto the second reel in order to provide the self-adhesive punched parts.

A section of the tape which comprises the second end is attached to the second reel core. In particular, it is provided that by rotating the second reel, the sections of the tape which are adjacent to the section of the tape which comprises the second end can be wound around the second reel core in order to unwind the tape step-by-step from the first reel and wind it onto the second reel, and thereby gradually expose the self-adhesive punched parts. In particular, it is provided that, when the tape has been unwound from the first reel and all the self-adhesive punched parts have been provided, a large portion of the tape is wound around the second reel core.

The tape is guided along a path from the first reel to the second reel. It is preferred that the path comprises multiple sections. For example, one section or multiple sections of the multiple sections can run along a straight line. Alternatively, or additionally, one section or multiple sections of the multiple sections can run along a circular section. For example, when the tape is guided along a deflection roller and the tape wraps around the deflection roller at least in sections, a section of the path can run along a circular section in the region of the deflection roller. In particular, it is provided that the path, starting from the first reel, comprises a section which runs along a straight line. This straight section preferably extends from the first reel to a deflection roller. It is further preferred that the straight section of the path is followed by a section of the path which runs along a circular section in the region of the deflection roller. In particular, multiple deflection rollers can be provided along the path between the first reel and the second reel. In this case, the circular section just described is followed by a further straight section of the path which extends from the deflection roller to a next deflection roller. At this next deflection roller, the straight section of the path is then followed by a section of the path which runs along a circular section in the region of this deflection roller. In this sense, the path can comprise multiple sections that are alternately straight and circular along the path. In particular, circular is to be understood here as meaning that a circular section of the path describes a section of the path that extends along a circular section. In particular, it is provided that the path is unwound from the first reel and wound onto the second reel. When the tape is unwound from the first reel and wound onto the second reel, the tape is guided along the path from the first reel to the second reel. Viewed along the path, the direction in which the tape is guided along a section of the path can also be referred to as the guiding direction. In particular, the self-adhesive punched parts which are arranged on the tape are moved along the guiding direction when the tape is unwound from the first reel and wound onto the second reel.

The cassette device comprises the guide unit which is arranged in the interior space of the housing and is connected to the housing. The guide unit is arranged in the interior space of the housing. By virtue of the fact that the guide unit is arranged in the interior space of the housing, the guide unit can be protected from environmental influences. In particular, contamination of the guide unit can be prevented by the housing. The guide unit is connected to the housing. A connection between the guide unit and the housing ensures that if the position or orientation of the housing changes, the position or orientation of the guide unit inevitably changes with it.

The guide unit is designed in such a manner that the tape is guided on the guide unit in such a manner that the first section of the path is opposite the first opening. In particular, the guide unit defines the geometry of the path by the manner in which the guide unit guides the tape. As already described, one or multiple deflection rollers can be provided between the first reel and the second reel. The geometry of the path can be determined in particular by the arrangement of the one or multiple deflection rollers, past which the tape is guided, in that at least one section of the tape rolls on the one or multiple deflection rollers. In particular, it is provided that the tape is guided on the guide unit in such a manner that the first section of the path is opposite the first opening. By virtue of the fact that the first section of the path is opposite the first opening, the tape can be guided past the first opening in sections.

In the region of the first section, the first side of the tape faces the first opening. By virtue of the fact that the first side of the tape faces the first opening in the region of the first section of the path, the self-adhesive punched parts which are arranged on the first side of the tape face the first opening in the region of the first section of the path. The self-adhesive punched parts can be conveyed from the first reel to the first opening in such a manner that the self-adhesive punched parts are arranged in the region of the first section of the path on the first side of the tape and facing the first opening.

The base device comprises the base body having the second connecting device, which is connected in a positive-locking and releasable manner to the first connecting device, and the third connecting device for connection to the manufacturing system. The second connecting device is designed so as to be connected in a positive-locking and releasable manner to the first connecting device. In particular, the third connecting device is designed so as to be connected in a positive-locking and releasable manner to a section of the manufacturing system.

The base device comprises the deflection unit which is arranged at least in sections in the interior space of the housing and comprises the deflection element which is attached to the free end. The base device comprises the deflection unit. In particular, the deflection unit can be arranged in such a manner that the deflection unit acts on a section of the tape in such a manner that the path, along which the tape is guided, is changed at least in sections. The deflection unit forms a section of the base device and, when the second connecting device is connected in a positive-locking and releasable manner to the first connecting device, is arranged at least in sections in the interior space of the housing. If the second connecting device is connected in a positive-locking and releasable manner to the first connecting device, the deflection unit can be protected at least in sections from environmental influences. In particular, contamination of a section of the deflection unit can be prevented in this case. The deflection unit comprises the free end to which the deflection element is attached. The deflection element can also be referred to as the dispensing edge. In particular, the deflection element can be arranged in such a manner that the deflection element acts on a section of the tape in such a manner that the path, along which the tape is guided, is changed at least in sections. In particular, the deflection element can comprise a deflection roller which can be brought into contact with the tape so that the deflection roller rolls on the tape. When the deflection roller has been brought into contact with the tape so that the deflection roller rolls on the tape, the path comprises in the region of this deflection roller a circular section which is followed by two straight sections on two opposite sides of the deflection roller. This means that the geometry of the path can be influenced by the deflection roller.

The deflection element is arranged on the second side of the tape which is opposite the first side of the tape and opposite the first section. By virtue of the fact that the deflection element is arranged on the second side of the tape, the deflection element can act on the tape in such a manner that the geometry of the path is changed without the deflection element coming into contact with the self-adhesive punched parts which are arranged on the first side. By virtue of the fact that the deflection element is arranged opposite the first section, the deflection element can act on the first section of the path. In particular, the deflection element can be brought into contact with the tape from the second side of the tape and the tape in the first section of the path can be moved in the direction of the first opening together with one or multiple self-adhesive punched parts which are arranged in this region on the second side of the tape.

The deflection unit is movably coupled to the base body in such a manner that the deflection unit can be moved between the retracted position and the extended position. The deflection unit can therefore be moved from the retracted position into the extended position and from the extended position into the retracted position. In particular, it is provided that the deflection unit is movably coupled to the base body in such a manner that the deflection unit can be moved between the retracted position and the extended position as well as an intermediate position. In this case, the deflection unit can be moved in particular from the retracted position into the intermediate position, from the intermediate position into the extended position, from the extended position into the intermediate position and from the intermediate position into the retracted position. Since the deflection unit can be moved as described here, the deflection element can also be referred to as an oscillating dispensing edge.

In the retracted position, the deflection element and the tape are arranged in the interior space. By virtue of the fact that the deflection element and the tape are arranged in the retracted position in the interior space, the deflection element and the tape can be protected from environmental influences. In particular, contamination of the deflection element and the tape can be prevented by the housing.

In the extended position, a subsection of the tape is in contact with the deflection element, and the deflection element and at least the subsection of the tape which is in contact with the deflection element are arranged in the external environment. The geometry of the path can be influenced by the positioning of the deflection element as a result of the subsection of the tape being in contact with the deflection element. By virtue of the fact that the deflection element is arranged in the external environment, the deflection element ensures that the subsection of the tape, and thus a section of the path, is arranged in the external environment. In particular, the second side of the tape is in contact with the deflection element, so that the subsection of the tape on the second side of the tape is in contact with the deflection element. By virtue of the fact that the subsection of the tape is arranged in the external environment, one self-adhesive punched part or multiple self-adhesive punched parts which are arranged in the region of the subsection on the second side of the tape can be provided in the external environment.

In particular, by virtue of the fact that the cassette device comprises the housing, the tape which comprises the self-adhesive punched parts is arranged in the interior space of the housing and only a subsection of the tape is arranged in the external environment in the extended position, the self-adhesive punched parts can be protected from environmental influences immediately until they are brought into the external environment as a result of a movement of the deflection unit into the extended position. The cassette device comprises the first and second reels on which the tape which comprises the self-adhesive punched parts is attached or wound. The application device thus comprises the cassette device, which in turn comprises the tape which comprises the self-adhesive punched parts. When the self-adhesive punched parts of the tape have been provided to the cassette device so that self-adhesive punched parts are no longer arranged on the tape, the cassette device can be removed from the application device by releasing the positive-locking and releasable connection between the first connecting device and the second connecting device. A further cassette device having a tape with self-adhesive punched parts can then be inserted into the application device by connecting in a positive-locking and releasable manner a first connecting device of the further cassette device to the second connecting device. When the self-adhesive punched parts of a first cassette device have been provided and the first cassette device thus no longer has any self-adhesive punched parts which it can provide, the first cassette device can be separated from the base device and a second cassette device having self-adhesive punched parts can be connected to the base device. By virtue of the fact that the application device comprises a cassette device according to the invention, the self-adhesive punched parts can be provided in a simple and quick manner, in particular if multiple self-adhesive punched parts are to be provided over a long period of time and in the case of this number of self-adhesive punched parts it is necessary when using application devices known from the prior art to replace the tape which comprises the self-adhesive punched parts. With the application device according to the invention, the provision of a plurality of self-adhesive punched parts is therefore particularly simple and fast, since only the cassette device has to be replaced and the connection between the cassette device and the base device can be released and established in a simple and quick manner. Replacing a tape in application devices known from the prior art, on the other hand, often takes more time, since the tape has to be positioned in the application device and threaded into the application device in such a manner that the tape runs along different deflection rollers.

According to a preferred embodiment of the invention, the temperature inside the cassette device can be purposefully controlled by conventional heating devices.

In summary, it can therefore be stated that an application device is provided with which self-adhesive punched parts can be provided in a simple and quick manner and the self-adhesive punched parts can be protected from environmental influences.

In one embodiment, the base device comprises a cylinder, a piston which can be moved in the cylinder along an effective axis and extends from one end along the effective axis to a second end, and a suction pad plunger which is attached to the second end of the piston, wherein the effective axis is oriented in such a manner that the suction pad plunger can be moved along the effective axis in such a manner that the suction pad plunger can then be brought into contact with a punched part on the tape when the deflection unit is in the extended position. It is preferred that the piston can be moved in the cylinder along the effective axis in such a manner that the piston can be moved between a first position and a second position. In particular, the piston can be moved from the first position into the second position and from the second position into the first position. It is further preferred that the piston can be moved in the cylinder along the effective axis in such a manner that the piston can be moved between a first position, a second position and a third position. In particular, the piston can be moved from the first position into the second position, from the second position into the third position, from the third position into the second position, and from the second position into the first position. In particular, it is provided that, when the deflection unit is in the extended position and the piston is in the first position, the suction pad plunger is not in contact with a punched part on the tape. It is further preferred that, when the deflection unit is in the extended position and the piston is in the second position, the suction pad plunger is in contact with a punched part on the tape.

The base device can comprise a vacuum source which can provide a vacuum at the suction pad plunger. In order to pick up a punched part, first the deflection unit can be moved into the extended position, next the piston can be moved into the second position so that the suction pad plunger comes into contact with the punched part on the tape and the vacuum which is provided at the suction pad plunger ensures that, when the piston is moved into the first position or the deflection unit is moved into the intermediate position or into the retracted position, the punched part remains on the suction pad plunger. After the deflection unit has been moved into the intermediate position or into the retracted position, the plunger can be moved into the third position so that the punched part with its adhesive surface can be applied to a workpiece. By ending the provision of the vacuum on the suction pad plunger, when the piston is moved back into the first position or into the second position, the punched part can remain attached to the workpiece by means of its pressure-sensitive adhesive surface.

In one embodiment, the travel path of the deflection unit during the movement between the retracted position and the extended position and the effective axis intersect. The fact that the travel path and the effective axis intersect one another, renders it possible, in the case of a mechanically robust structure in which the suction pad plunger is attached to the second end of the piston in such a manner that the suction pad plunger viewed in a direction from the first end to the second end is arranged along the effective axis downstream of the second end, for the suction pad plunger and a punched part which is arranged on the tape to be brought into contact with one another.

In one embodiment, the guide unit comprises a first and a second deflection roller, wherein the first section of the path is arranged between the first deflection roller and the second deflection roller. With the aid of the first deflection roller and the second deflection roller, the guide unit can provide a straight section of the path into which the deflection unit can engage with the tape.

In one embodiment, a second opening is formed in the housing and connects the interior space of the housing to the external environment of the housing, wherein the guide unit is designed in such a manner that the tape is guided on the guide unit in such a manner that a second section of the path is opposite the second opening, wherein in the region of the second section the first side of the tape faces the second opening, wherein the base device comprises a clamping means, in particular in the form of a pneumatic cylinder which presses on a counter-pressure plate, which is arranged in such a manner that the second opening is arranged between the clamping means and the second section. By virtue of the fact that the second opening connects the interior space of the housing to the external environment of the housing, the second opening enables the clamping means to be arranged in the external environment of the housing.

In one embodiment, the first connecting device comprises a recess and the second connecting device comprises a positioning pin that engages in the recess. With the aid of the recess and the positioning pin, the cassette device and the base device can be arranged in a particularly advantageous manner in relation to one another.

In one embodiment, the second connecting device comprises a recess and the first connecting device comprises a positioning pin that engages in the recess. With the aid of the recess and the positioning pin, the cassette device and the base device can be arranged in a particularly advantageous manner in relation to one another.

In one embodiment, the base device comprises a first actuator which can drive a shaft for rotation about a shaft axis of rotation, wherein the shaft is coupled to the second reel in such a manner that rotation of the shaft about the shaft axis of rotation causes the second reel to rotate about the second axis of rotation. The first actuator can thus be used to cause the second reel to rotate about the second axis of rotation.

In one embodiment, the base device comprises a second actuator for moving the deflection unit between the retracted position and the extended position. The second actuator can thus be used to cause the deflection unit to move.

In one embodiment, the cassette device comprises a data storage device having cassette device-related data and the base device comprises a first acquisition unit which is designed to acquire the cassette device-related data. The cassette device-related data may include, for example, a date of manufacture of the cassette device, a batch number of the cassette device, tape-related data, such as for example the tape material, or punched part-related data, such as the punched part material. With the aid of the first acquisition unit, the cassette device-related data can be provided within the base device. For example, the cassette device-related data can be used to check whether the correct cassette device is attached to the base device for a particular manufacturing step.

In one embodiment, the guide unit comprises a first and a second deflection roller, wherein the first section of the path is arranged between the first deflection roller and the second deflection roller. With the aid of the first deflection roller and the second deflection roller, the guide unit can provide a straight section of the path into which the deflection unit can engage with the tape.

In one embodiment, a second opening is formed in the housing and connects the interior space of the housing to the external environment of the housing, wherein the guide unit is designed in such a manner that the tape is guided on the guide unit in such a manner that a second section of the path is opposite the second opening, wherein in the region of the second section the first side of the tape faces the second opening. By virtue of the fact that the second opening connects the interior space of the housing to the external environment of the housing, the second opening enables the clamping means to be arranged in the external environment of the housing.

In one embodiment, the first connecting device comprises a recess which is arranged and designed in such a manner that, when the first connecting device and the second connecting device are connected in a positive-locking and releasable manner to one another, a positioning pin of the second connecting device engages in the recess. With the aid of the recess and the positioning pin, the cassette device and the base device can be arranged in a particularly advantageous manner in relation to one another.

In one embodiment, the first connecting device comprises a positioning pin which is arranged and designed in such a manner that, when the first connecting device and the second connecting device are connected in a positive-locking and releasable manner to one another, the positioning pin engages in a recess of the second connecting device. With the aid of the recess and the positioning pin, the cassette device and the base device can be arranged in a particularly advantageous manner in relation to one another.

In one embodiment, the cassette device comprises a data storage device having cassette device-related data which can be acquired by a first acquisition unit of the base device. The cassette device-related data may include, for example, a date of manufacture of the cassette device, a batch number of the cassette device, tape-related data, such as the tape material, or punched part-related data, such as the punched part material. With the aid of the first acquisition unit, the cassette device-related data can be provided within the base device. For example, the cassette device-related data can be used to check whether the correct cassette device is attached to the base device for a particular manufacturing step.

In one embodiment, the base device comprises a cylinder, a piston which can be moved in the cylinder along an effective axis and extends from one end along the effective axis to a second end, and a suction pad plunger which is attached to the second end of the piston, wherein, when the first connecting device and the second connecting device are connected in a positive-locking and releasable manner to one another, the effective axis is oriented in such a manner that the suction pad plunger can be moved along the effective axis in such a manner that the suction pad plunger can then be brought into contact with a punched part on the tape when the deflection unit is in the extended position. It is preferred that the piston can be moved in the cylinder along the effective axis in such a manner that the piston can be moved between a first position and a second position. In particular, the piston can be moved from the first position into the second position and from the second position into the first position. It is further preferred that the piston can be moved in the cylinder along the effective axis in such a manner that the piston can be moved between a first position, a second position and a third position. In particular, the piston can be moved from the first position into the second position, from the second position into the third position, from the third position into the second position, and from the second position into the first position. In particular, it is provided that, when the deflection unit is in the extended position and the piston is in the first position, the suction pad plunger is not in contact with a punched part on the tape. It is further preferred that, when the deflection unit is in the extended position and the piston is in the second position, the suction pad plunger is in contact with a punched part on the tape.

The base device can comprise a vacuum source which can provide a vacuum at the suction pad plunger. In order to pick up a punched part, first the deflection unit can be moved into the extended position, next the piston can be moved into the second position so that the suction pad plunger comes into contact with the punched part on the tape and the vacuum which is provided at the suction pad plunger ensures that, when the piston is moved into the first position or the deflection unit is moved into the intermediate position or into the retracted position, the punched part remains on the suction pad plunger. After the deflection unit has been moved into the intermediate position or into the retracted position, the plunger can be moved into the third position so that the punched part with its pressure-sensitive adhesive surface can be applied to a workpiece. By ending the provision of the vacuum on the suction pad plunger, when the piston is moved back into the first position or into the second position, the punched part can remain attached to the workpiece by means of its pressure-sensitive adhesive surface.

In one embodiment, the base device comprises a clamping means, in particular in the form of a pneumatic cylinder which presses on a counter-pressure plate, which, when the first connecting device of a cassette device according to the second aspect and the second connecting 18 device are connected in a positive-locking and releasable manner to one another, is arranged in such a manner that the second opening is arranged between the clamping means and the second section of the path. By virtue of the fact that the second opening connects the interior space of the housing to the external environment of the housing, the second opening renders it possible that the clamping means can be arranged in the external environment of the housing and, through the second opening in the region of the second section of the path, can engage the first side of the tape, which is arranged in the interior space, and, in particular, engage self-adhesive punched parts which are arranged on the tape.

In one embodiment, the second connecting device comprises a positioning pin which is arranged and designed in such a manner that, when the first connecting device of a cassette device according to the second aspect and the second connecting device are connected in a positive-locking and releasable manner to one another, the positioning pin engages in the recess of the first connecting device. With the aid of the recess and the positioning pin, the cassette device and the base device can be arranged in a particularly advantageous manner in relation to one another.

In one embodiment, the second connecting device comprises a recess which is arranged and designed in such a manner that, when the first connecting device of a cassette device according to the second aspect and the second connecting device are connected in a positive-locking and releasable manner to one another, the positioning pin of the first connecting device engages in the recess. With the aid of the recess and the positioning pin, the cassette device and the base device can be arranged in a particularly advantageous manner in relation to one another.

In one embodiment, the base device comprises a first actuator which can drive a shaft for rotation about a shaft axis of rotation, wherein the shaft can be coupled to the second reel in such a manner that rotation of the shaft about the shaft axis of rotation causes the second reel to rotate about the second axis of rotation. The first actuator can thus be used to cause the second reel to rotate about the second axis of rotation.

In one embodiment, the base device comprises a second actuator for moving the deflection unit between the retracted position and the extended position. The second actuator can thus be used to cause the deflection unit to move.

In one embodiment, the base device comprises a first acquisition unit which is designed so as to acquire cassette device-related data of a data storage device of the cassette device according to the second aspect. The cassette device-related data may include, for example, a date of manufacture of the cassette device, a batch number of the cassette device, tape-related data, such as the tape material, or punched part-related data, such as the punched part material. With the aid of the first acquisition unit, the cassette device-related data can be provided within the base device. For example, the cassette device-related data can be used to check whether the correct cassette device is attached to the base device for a particular manufacturing step.

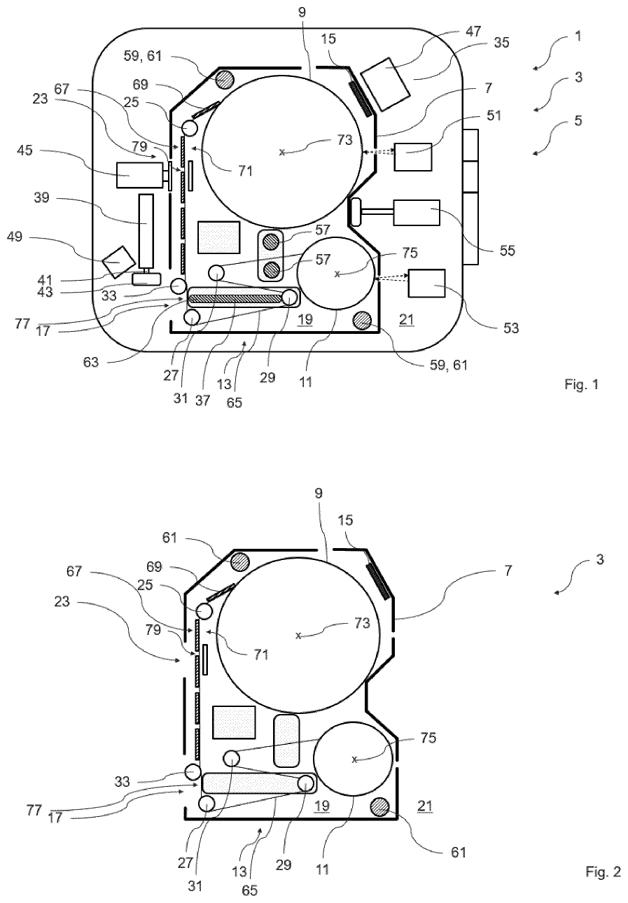

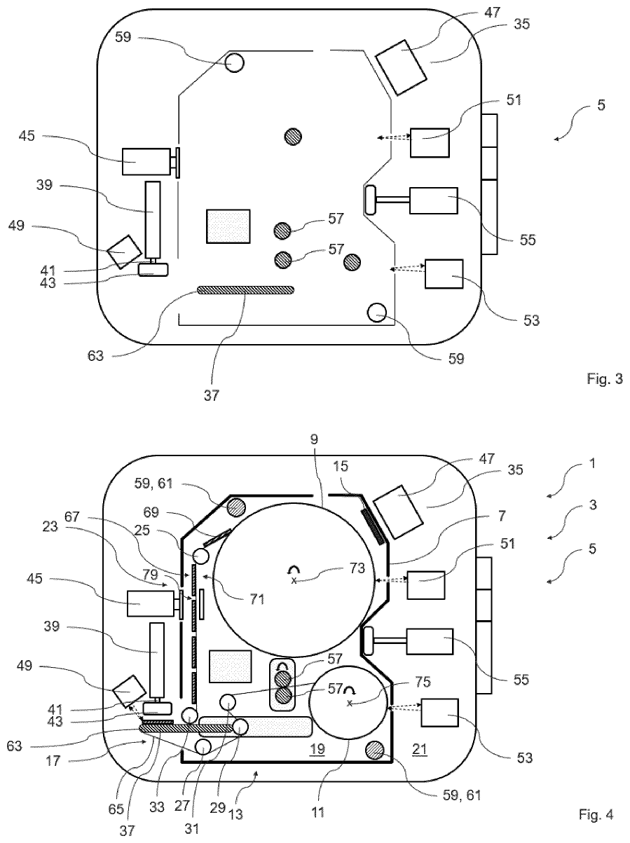

FIG. 1 shows a schematic view of an embodiment of an application device 1 according to the invention. The application device 1 comprises a cassette device 3 and a base device 5. FIG. 2 shows a schematic view of an embodiment of the cassette device 3 according to the invention of the application device 1 in FIG. 1. FIG. 3 shows a schematic view of an embodiment of the base device 5 according to the invention of the application device 1 in FIG. 1.

The cassette device 3 comprises a housing 7, a first reel 9 having a first reel core, a second reel 11 having a second reel core, a guide unit 13 and a data storage device 15. A first opening 17 is formed in the housing 7. The first opening 17 connects an interior space 19 of the housing 7 to an external environment 21 of the housing 7. In addition to the first opening 17, a second opening 23 is formed in the housing 7. The second opening 23 also connects the interior space 19 of the housing 7 to the external environment 21 of the housing 7. By virtue of the fact that the first opening 17 and the second opening 23 each connect the interior space 19 of the housing 7 to the external environment 21 of the housing 7, the first opening 17 and the second opening 23 enable an element of the application device 1 to extend through the first opening 17 and/or through the second opening 23. The housing 7 comprises a wall. The wall comprises an inner surface and an outer surface. The inner surface faces the interior space 19. The outer surface faces the external environment 21. The housing 7, in particular with its wall, separates the interior space 19 and the external environment 21 from one another. By virtue of the interior space 19 and the external environment 21 being separated from one another, the housing 7 can prevent contamination of the interior space 19 and of elements arranged in the interior space 19. For example, contamination of these elements can be prevented by the housing 7. The housing 7 comprises a first connecting device. The first connecting device is designed so as to be connected in a positive-locking and non-releasable manner to a second connecting device. The guide unit 13 comprises a first deflection roller 25, a second deflection roller 27, a third deflection roller 29, a fourth deflection roller 31 and a fifth deflection roller 33. The data storage device 15 comprises cassette device-related data.

The base device 5 comprises a base body 35, a deflection unit 37, a cylinder 39, a piston 41, a suction pad plunger 43, a clamping means 45, a first acquisition unit 47, a second acquisition unit 49, a third acquisition unit 51, a fourth acquisition unit 53, a cassette fixing means 55, two conveyor rollers 57 and two recesses 59. A positioning pin 61 of two positioning pins 61 of the cassette device 3 engages in each recess 59. Furthermore, the base device 5 comprises a first actuator and a second actuator. The base body 35 comprises a second connecting device, which is connected in a positive-locking and releasable manner to the first connecting device. The second connecting device is designed so as to be connected in a positive-locking and releasable manner to the first connecting device. The second connecting device comprises the two recesses 59 and the first connecting device comprises the two positioning pins 61. Furthermore, the base body 35 comprises a third connecting device, which is designed to be connected in a positive-locking and releasable manner to a manufacturing system, in particular to a section of the manufacturing system. The deflection unit 37 comprises a deflection element 63. The deflection element 63 is attached to a free end of the deflection unit 37. The first acquisition unit 47 is designed so as to acquire the cassette device-related data of the data storage device 15.

A tape 65 is accommodated in the interior space 19. The tape 65 is arranged in the interior space 19. By virtue of the fact that the tape 65 is accommodated in the interior space 19, the tape 65 can be protected from environmental influences. In particular, contamination of the tape 65 can be prevented by the housing 7. The tape 65 extends from a first end to a second end. The tape is rolled up at least in sections and extends between the rolled-up sections along multiple non-rolled-up sections, in each case along a corresponding straight line or plane or along a circular section. Self-adhesive punched parts 69 are arranged on the tape 65 on a first side 67. Each self-adhesive punched part 69 of the self-adhesive punched parts 69 comprises a pressure-sensitive adhesive surface. Each self-adhesive punched part 69 is attached by means of its pressure-sensitive adhesive surface to the tape 65. The self-adhesive punched parts 69 can be detached from the tape 65 and then applied to a workpiece in such a manner that the self-adhesive punched parts 69 are bonded to the workpiece by means of their pressure-sensitive adhesive surface.

No punched parts 69 are arranged on a second side 71 of the tape 65 and the second side is opposite the first side 67 of the tape 65. The tape 65 is wound around the first reel core of the first reel 9 with a section which comprises the first end of the tape 65. In particular, it is provided that the tape 65 is wound around the first reel core with a section which comprises the section which comprises the first end of the tape and, by rotating the first reel 9, this section of the tape can be unwound at least in sections from the first reel 9 in order to provide the self-adhesive punched parts 69. It is preferred that, when a large portion of the tape 65 is unwound from the first reel 9, the section having the first end is wound at least in sections around the first reel core. In particular, it is provided that, when the tape 65 has been unwound from the first reel 9 and all self-adhesive punched parts 69 have been provided, the section having the first end is attached to the first reel core. A section of the tape 65 which comprises the second end of the tape 65 is attached to the second reel core of the second reel 11. It is provided that by rotating the second reel 11, the sections of the tape 65 which are adjacent to the section of the tape 65 which comprises the second end can be wound around the second reel core in order to unwind the tape 65 step-by-step from the first reel 9 and wind it onto the second reel 11, and thereby gradually expose the self-adhesive punched parts 69. Then, when the tape 65 has been unwound from the first reel 9 and all the self-adhesive punched parts 69 have been provided, a large portion of the tape is wound around the second reel core.

The first reel 9 is arranged in the interior space 19 of the housing 7 and mounted on the housing 7 in such a manner so as to be able to rotate about a first axis of rotation 73. By virtue of the fact that the first reel 9 is arranged in the interior space 19 of the housing 7, the first reel 9 can be protected from environmental influences. In particular, contamination of the first reel 9 can be prevented by the housing 7. The first reel 9 is mounted on the housing 7 in order to be able to rotate about the first axis of rotation 73. By virtue of the rotatable mounting of the first reel 9, the tape 65 can be unwound on and from the first reel 9 by rotating the first reel 9 about the first reel 9. In particular, it is provided that the tape 65 is wound around the first reel core of the first reel 9 with a section and, by rotating the first reel 9, this section of the tape 65 can be unwound at least in sections from the first reel 9 in order to provide the self-adhesive punched parts 69.

The second reel 11 is arranged in the interior space 19 of the housing 7. By virtue of the fact that the second reel 11 is arranged in the interior space 19 of the housing 7, the second reel 11 can be protected from environmental influences. In particular, contamination of the second reel 11 can be prevented by the housing 7. The second reel 11 is attached to the housing 7 and mounted in such a manner so as to be able to rotate about the second axis of rotation 75. By virtue of the rotatable mounting of the second reel 11, the tape 65 can be unwound on and from the second reel 11 by rotating the second reel 11 about the second reel 11. In particular, it is provided that the tape 65 is wound with a section around the second reel core and, by rotating the second reel 11, this section of the tape can be wound at least in sections onto the second reel 11 in order to provide the self-adhesive punched parts.

The tape 65 is guided along a path from the first reel 9 to the second reel 11. The path comprises multiple subsections. A first subsection of the path between the first reel 9 and the first deflection roller 25, a second subsection of the path between the first deflection roller 25 and the second deflection roller 27, a third subsection of the path between the second deflection roller 27 and the third deflection roller 29, a fourth subsection of the path between the third deflection roller 29 and the fourth deflection roller 31, and a fifth subsection of the path between the fourth deflection roller 31 and the second reel 11 each run along a straight line. A sixth subsection of the path which is arranged between the first subsection of the path and the second subsection of the path, a seventh subsection of the path which is arranged between the second subsection of the path and the third subsection of the path, an eighth subsection of the path which is arranged between the third subsection of the path and the fourth subsection of the path, and a ninth subsection of the path which is arranged between the fourth subsection of the path and the fifth subsection of the path, each run along a circular section. The path therefore comprises multiple subsections which are alternately straight and circular along the path. In particular, circular is to be understood here as meaning that a circular subsection of the path describes a subsection of the path that extends along a circular section.

As the first reel 9 rotates about the first axis of rotation 73 and the second reel 11 rotates about the second axis of rotation 75, sections of the tape 65 are moved along the path from the first reel 9 to the second reel 11. In other words, the tape 65 is guided along the path from the first reel 9 to the second reel 11. Viewed along the path, the direction in which the tape 65 is guided along a section of the path can also be referred to as the guiding direction. In particular, the self-adhesive punched parts 69 which are arranged on the tape 65 are moved along the guiding direction when the tape 65 is unwound from the first reel 9 and wound onto the second reel 11. As already described, the base device 5 comprises the first actuator. The first actuator can drive a shaft for rotation about a shaft axis of rotation. The shaft is coupled to the second reel 11 in such a manner that a rotation of the shaft about the shaft axis of rotation causes a rotation of the second reel 11 about the second axis of rotation 75.

The guide unit 13 is also arranged in the interior space 19 of the housing 7. By virtue of the fact that the guide unit 13 is arranged in the interior space 19 of the housing 7, the guide unit 13 can be protected from environmental influences. In particular, contamination of the guide unit 13 can be prevented by the housing 7. The guide unit 13 is connected to the housing 7. A connection between the guide unit 13 and the housing 7 ensures that if the position or orientation of the housing 7 changes, the position or orientation of the guide unit 13 inevitably changes with it. As already described, the guide unit 13 comprises the first deflection roller 25, the second deflection roller 27, the third deflection roller 29, the fourth deflection roller 31 and the fifth deflection roller 33. This configuration of the guide unit 13 is a particularly mechanically robust and simple possibility of configuring the guide unit 13 in such a manner that the tape 65 is guided on the guide unit 13 in such a manner that a first section 77 of the path is opposite the first opening 17. The first section 77 of the path is arranged at the lower end of the second subsection of the path described above, as shown in FIG. 1, and is formed by a section of the second subsection of the path. The guide unit 13 defines the geometry of the path by how the guide unit 13 guides the tape 65. In particular, the guide unit 13 defines the geometry of the path with the aid of the first deflection roller 25, the second deflection roller 27, the third deflection roller 29, the fourth deflection roller 31 and the fifth deflection roller 33. By virtue of the fact that the first section 77 of the path is opposite the first opening 17, the tape 65 can be guided past the first opening 17 in sections. In the region of the first section 77 of the path, the first side 67 of the tape 65 faces the first opening 17.

By virtue of the fact that in the region of the first section 77 of the path, the first side 67 of the tape 65 faces the first opening 17, the self-adhesive punched parts 69 which are arranged on the first side 67 of the tape 65 face the first opening 17 in the region of the first section 77 of the path. The self-adhesive punched parts 69 can be conveyed from the first reel 9 to the first opening 17 in such a manner that the self-adhesive punched parts 69 are arranged in the region of the first section 77 of the path on the first side 67 of the tape 65 and facing the first opening 17. The first section 77 of the path is arranged between the first deflection roller 25 and the second deflection roller 27 and between the fifth deflection roller 33 and the second deflection roller 27. With the aid of the first deflection roller 25 and the second deflection roller 27, the guide unit 13 can provide a straight section of the path into which the deflection unit 37 can engage with the tape 65. The fifth deflection roller 33 ensures that, when the deflection unit 37 engages with the tape 65, the tape 65 is guided at a distance from the housing 7. Furthermore, the guide unit 13 is designed in such a manner that the tape 65 is guided on the guide unit 13 in such a manner that a second section 79 of the path is opposite the second opening 23. In the region of the first section 79, the first side 67 of the tape 65 faces the second opening 23. As already described, the base device 5 comprises the clamping means 45. The clamping means 45 is arranged in such a manner that the second opening 23 is arranged between the clamping means 45 and the second section 79.

The deflection unit 37 can be arranged in such a manner that the deflection unit 37 acts on a section of the tape 65 in such a manner that the path, along which the tape 65 is guided, is changed at least in sections. The deflection unit 37 forms a section of the base device 5 and, when the second connecting device is connected in a positive-locking and releasable manner to the first connecting device, is arranged at least in sections in the interior space 19 of the housing 7. When the second connecting device is connected in a positive-locking and releasable manner to the first connecting device, the deflection unit 37 can be protected at least in sections from environmental influences. In particular, contamination of a section of the deflection unit 37 can be prevented in this case. The deflection unit 37 comprises the free end to which the deflection element 63 is attached. The deflection unit 63 can be arranged in such a manner that the deflection unit 63 acts on a section of the tape 65 in such a manner that the path, along which the tape 65 is guided, is changed at least in sections. In particular, the deflection element can comprise a deflection roller which can be brought into contact with the tape 65 so that the deflection roller rolls on the tape. When the deflection roller has been brought into contact with the tape 65 so that the deflection roller rolls on the tape 65, the path comprises a circular section in the region of this deflection roller and the circular section is followed by two straight sections on two opposite sides of the deflection roller. This means that the geometry of the path can be influenced by the deflection roller.

The deflection element 63 of the deflection unit 37 is arranged on the second side 71 of the tape 65. Furthermore, the deflection element 63 is arranged opposite the first section 77 of the path. By virtue of the fact that the deflection element 63 is arranged on the second side 71 of the tape 65, the deflection element 63 can act on the tape 65 in such a manner that the geometry of the path is changed without the deflection element 63 coming into contact with the self-adhesive punched parts 69 which are arranged on the first side 67. By virtue of the fact that the deflection element 63 is arranged opposite the first section 77, the deflection element 63 can act on the first section 77 of the path. In particular, the deflection element can be brought into contact with the tape 65 from the second side 71 of the tape 65 and the tape 65 in the first section 77 of the path can be moved in the direction of the first opening 17 together with one or multiple self-adhesive punched parts 69 which are arranged in this region on the second side 71 of the tape 65.

The deflection unit 37 is movably coupled to the base body 35. FIG. 1 shows the deflection unit 37 in a retracted position. In the retracted position, the deflection element 63 and the tape 65 are arranged in the interior space 19. By virtue of the fact that the deflection element 63 and the tape 65 are arranged in the retracted position in the interior space 19, the deflection element 63 and the tape 65 can be protected from environmental influences. In particular, contamination of the deflection element 63 and the tape 65 can be prevented by the housing 7.

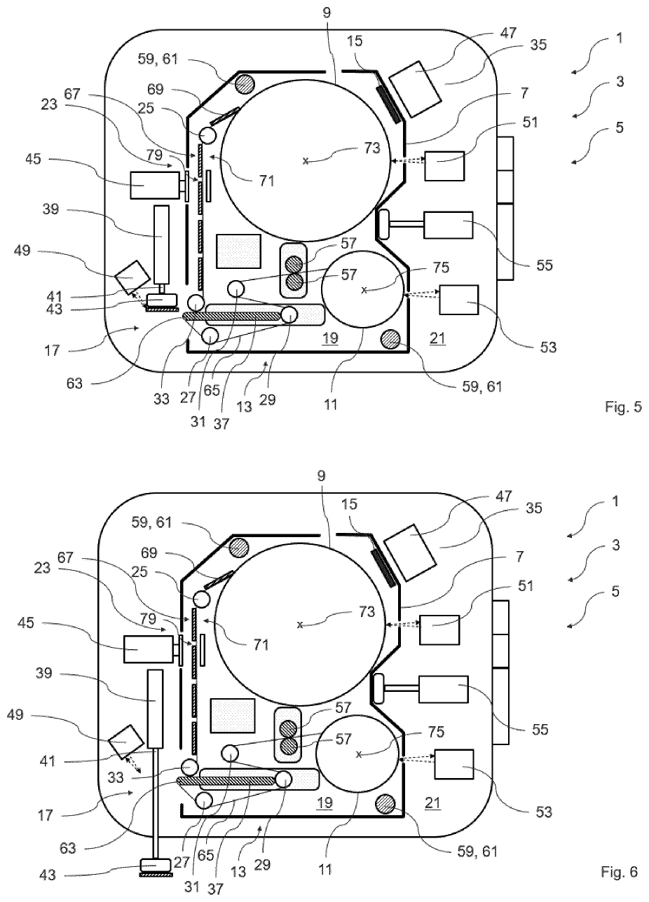

FIGS. 4, 5 and 6 show the application device 1 in FIG. 1. As already described, the deflection unit is arranged in the retracted position in FIG. 1. In FIG. 4, the deflection unit is arranged in an extended position and in FIGS. 5 and 6, the deflection unit is arranged in an intermediate position. The deflection unit 37 is movably coupled to the base body 35 in such a manner that the deflection unit 37 can be moved between a retracted position and an extended position and the intermediate position. The deflection unit 37 can be moved from the retracted position into the intermediate position, from the intermediate position into the extended position, from the extended position into the intermediate position and from the intermediate position into the retracted position. In the extended position, a subsection of the tape 65 is in contact with the deflection element 63 and the deflection element 63 and at least the subsection of the tape 65 which is in contact with the deflection element 63 are arranged in the external environment 21.

The geometry of the path can be influenced by the positioning of the deflection element 63 as a result of the contact of the subsection of the tape 65 with the deflection element 63. By virtue of the fact that the deflection element 63 is arranged in the external environment 21, the deflection element 63 ensures that the subsection of the tape 65, and thus a section of the path, is arranged in the external environment 21. In particular, the second side 71 of the tape 65 is in contact with the deflection element 63, so that the subsection of the tape 65 on the second side 71 of the tape 65 is in contact with the deflection element 63. By virtue of the fact that the subsection of the tape 65 is arranged in the external environment 21, one self-adhesive punched part 69 or multiple self-adhesive punched parts 69 which are arranged in the region of the subsection on the second side 71 of the tape 65 can be provided in the external environment 21. As already described, the base device 5 comprises the first actuator. The second actuator is designed so as to drive the movement of the deflection unit 37 between the retracted position, the intermediate position and the extended position.

As already described, the base device 5 comprises the cylinder 39 and the piston 41. The piston 41 can be moved into the cylinder 39 along an effective axis. In FIG. 4, the piston 41 is arranged in the first position, in FIG. 5 the piston is arranged in a second position and in FIG. 6 the piston is arranged in a third position. The piston 41 extends from one end along the effective axis to a second end. The suction pad plunger 43 is attached to the second end of the piston 41.

The suction pad plunger 43 can therefore be moved along the effective axis. In so doing, the effective axis is oriented in such a manner that the suction pad plunger 43 can be moved along the effective axis in such a manner that the suction pad plunger 43 can then be brought into contact with a punched part on the tape 65 when the deflection unit 37 is in the extended position. The effective axis is arranged in such a manner that the effective axis and the travel path of the deflection unit 37 intersect during the movement between the retracted position and the extended position. The fact that the travel path and the effective axis intersect one another renders it possible, in the case of a mechanically robust structure as shown in FIGS. 1 and 3-6, in which the suction pad plunger 43 is attached to the second end of the piston 41 in such a manner that the suction pad plunger is arranged downstream of the second end viewed in a direction from the first end to the second end along the effective axis, for the suction pad plunger 43 and a punched part 69 which is arranged on the tape 65 to be brought into contact with one another.

The piston 41 can be moved in the cylinder 39 along the effective axis in such a manner that the piston 41 can be moved between the first position, the second position and the third position. In particular, the piston 41 can be moved from the first position into the second position, from the second position into the third position, from the third position into the second position, and from the second position into the first position. Then, when the deflection unit 37 is in the extended position and the piston 41 is in the first position, the suction pad plunger 43 is not in contact with a punched part 69 on the tape 65. Then, when the deflection unit 37 is in the extended position and the piston 41 is in the second position, the suction pad plunger 43 is in contact with a punched part 69 on the tape 65. The base device 5 comprises a vacuum source which can provide a vacuum at the suction pad plunger 43. In order to pick up a punched part 69, the deflection unit 37 is first moved into the extended position. Next, the piston 41 is moved into the second position so that the suction pad plunger 43 comes into contact with the punched part 69 on the tape 65. Next, the vacuum which is provided on the suction pad plunger 43 ensures that, when the piston 41 is moved into the first position and/or the deflection unit 37 is moved into the intermediate position or into the retracted position, the punched part 69 remains on the suction pad plunger 43. After the deflection unit 37 has been moved into the intermediate position or into the retracted position, the piston 41 can be moved into the third position so that the punched part 39 with its pressure-sensitive adhesive surface can be applied to a workpiece.

By ending the provision of the vacuum on the suction pad plunger 43, it is possible, when the piston 41 is moved back into the first position or into the second position, for the punched part 69 to remain attached by means of its pressure-sensitive adhesive surface to the workpiece.

The application device 1 described here, the cassette device 3 and the base device 5 are adapted for a robot device and a manufacturing system. The robot device comprises a frame and a robotic arm. The first end of the robotic arm is attached to the frame. The second end of the robotic arm is attached to the third connecting device of the base device. The manufacturing system comprises the robot device and a changing station. The changing station comprises a plurality of cassette devices 3, which are arranged in the changing station.

In particular, by virtue of the fact that the cassette device 3 comprises the housing 7, the tape 65 with the self-adhesive punched parts 69 is arranged in the interior space 19 of the housing 7 and only in the intermediate position and in the extended position is a subsection of the tape 65 arranged in the external environment 21, the self-adhesive punched parts 69 can be protected from environmental influences immediately until they are brought into the external environment 21 as a result of a movement of the deflection unit 37 into the extended position or into the intermediate position. The cassette device 3 comprises the first reel 9 and the second reel 11, to which the tape 65 with the self-adhesive punched parts 69 is attached or wound on. The application device 1 thus comprises the cassette device 3, which in turn comprises the tape 65 with the self-adhesive punched parts 69. When the self-adhesive punched parts 69 of the tape 65 of the cassette device 3 have been provided, so that self-adhesive punched parts 69 are no longer arranged on the tape 65, the cassette device 3 can be removed from the application device 1 by releasing the positive-locking and releasable connection between the first connecting device and the second connecting device. Subsequently, a further cassette device 3 with a tape 65 with self-adhesive punched parts 69 can be inserted into the application device 1, in that a first connecting device of the further cassette device 3 is connected in a positive-locking and releasable manner to the second connecting device. When the self-adhesive punched parts 69 of a first cassette device 3 have been provided and the first cassette device 3 thus no longer has any self-adhesive punched parts 69 which it can provide, the first cassette device 3 can be separated from the base device 5 and a second cassette device 3 with self-adhesive punched parts 69 can be connected to the base device 5. By virtue of the fact that the application device 1 comprises a cassette device 3 according to the invention, the self-adhesive punched parts 69 can be provided in a simple and quick manner, in particular if multiple self-adhesive punched parts 69 are to be provided over a long period of time and in the case of this number of self-adhesive punched parts 69 it would be necessary when using application devices known from the prior art to replace a tape which comprises the self-adhesive punched parts. With the application device 1 according to the invention, the provision of a plurality of self-adhesive punched parts 69 is therefore particularly simple and quick, since only the cassette device 3 has to be replaced and the connection between the cassette device 3 and the base device 5 can be released and established in a simple and quick manner. Replacing a tape in application devices known from the prior art, on the other hand, often takes more time, since the tape has to be positioned in the application device and threaded into the application device in such a manner that the tape runs along different deflection rollers.

In addition, it should be noted that “comprising” does not exclude other elements or steps and “one” or “a” does not exclude a plurality. Furthermore, it should be noted that features which are described with reference to one of the above exemplary embodiments may also be used in combination with other features of other exemplary embodiments described above. Reference signs in the claims are not to be regarded as a limitation.

### REFERENCE SIGNS

1 Application device
3 Cassette device
5 Base device
7 Housing
9 First reel
11 Second reel
13 Guide unit
15 Data storage device
17 First opening
19 Interior space of the housing
21 External environment of the housing
23 Second opening
25 First deflection roller
27 Second deflection roller
29 Third deflection roller
31 Fourth deflection roller
33 Fifth deflection roller
35 Base body
37 Deflection unit
39 Cylinder
41 Piston
43 Suction pad plunger
45 Clamping means
47 First acquisition unit
49 Second acquisition unit
51 Third acquisition unit
53 Fourth acquisition unit
55 Cassette fixing means
57 Conveyor roller
59 Recess
61 Positioning pin
63 Deflection element
65 Tape
67 First side of the tape
69 Punched part
71 Second side of the tape
73 First axis of rotation
75 Second axis of rotation
77 First section of the path
79 Second section of the path

1.-20. (canceled)

21. An application device, comprising:
a cassette device; and
a base device,
wherein the cassette device comprises a housing having a first connecting device, wherein a first opening is formed in the housing and connects an interior space of the housing to an external environment of the housing,
wherein the interior space can accommodate a tape, the tape extending from a first end to a second end and self-adhesive punched parts are arranged on the tape on a first side,
wherein the cassette device comprises a first reel arranged in the interior space of the housing and mounted on the housing so as to be able to rotate about a first axis of rotation, the first reel comprising a first reel core, and further wherein the tape is wound around the first reel core with a section which comprises the first end,
wherein the cassette device comprises a second reel arranged in the interior space of the housing and mounted on the housing so as to be able to rotate about a second axis of rotation, the second reel comprising a second reel core to which is attached a section of the tape which comprises the second end,
wherein the tape is guided along a path from the first reel to the second reel,
wherein the cassette device comprises a guide unit arranged in the interior space of the housing and connected to the housing, the guide unit configured such that the tape is guided in such a manner that a first section of the path is opposite the first opening and the first side of the tape faces the first opening in the first section,
wherein the base device comprises a base body having a second connecting device that is connected in a positive-locking and releasable manner to the first connecting device, and a third connecting device for connection to a manufacturing system, and
further wherein the base device comprises a deflection unit that is arranged at least partially in the interior space of the housing and comprises a free end and a deflection element attached to the free end, the deflection unit arranged on a second side of the tape that is opposite the first side of the tape and the first section of the path, wherein the deflection unit is movably coupled to the base body in such a manner that the deflection unit can be moved between a retracted position and an extended position along a travel path, wherein in the retracted position the deflection element and the tape are arranged in the interior space, and wherein in the extended position a subsection of the tape is in contact with the deflection element, and the deflection element and at least the subsection of the tape which is in contact with the deflection element are arranged in the external environment.

22. The application device of claim 21, wherein the base device further comprises a cylinder; a piston that can be moved in the cylinder along an effective axis and that extends from one end along the effective axis to a second end; and a suction pad plunger attached to the second end of the piston, wherein the effective axis is oriented such that the suction pad plunger can be moved along the effective axis such that the suction pad plunger can then be brought into contact with a punched part on the tape when the deflection unit is in the extended position.

23. The application device of claim 22, wherein the travel path of the deflection unit during movement of the deflection unit between the retracted position and the extended position and the effective axis intersect.

24. The application device of claim 21, wherein the guide unit comprises a first deflection roller and a second deflection roller, wherein the first section of the path is between the first deflection roller and the second deflection roller.

25. The application device of claim 21, wherein a second opening is formed in the housing and connects the interior space of the housing to the external environment of the housing, wherein the guide unit is configured such that the tape is guided on the guide unit such that a second section of the path is opposite the second opening, wherein the first side of the tape faces the second opening in the second section of the path, wherein the base device further comprises a clamping means arranged such that the second opening is arranged between the clamping means and the second section of the path.

26. The application device of claim 21, wherein the base device further comprises a first actuator configured to drive a shaft in rotation about a shaft axis, wherein the shaft is coupled to the second reel of the cassette device such that a rotation of the shaft about the shaft axis causes a rotation of the second reel about the second axis of rotation.

27. The application device of claim 26, wherein the base device further comprises a second actuator for moving the deflection unit between the retracted position and the extended position.

28. The application device of claim 21, wherein the cassette device further comprises a data storage device having cassette device-related data, and wherein the base device further comprises a first acquisition unit configured to acquire the cassette device-related data.

29. A cassette device, comprising:
a housing having a first connecting device configured to be connected in a positive-locking and releasable manner to a second connecting device of a base body of a base device,
wherein a first opening is formed in the housing and connects an interior space of the housing to an external environment of the housing,
wherein the interior space can accommodate a tape, the tape extending from a first end to a second end and self-adhesive punched parts are arranged on the tape on a first side,
wherein the cassette device comprises a first reel arranged in the interior space of the housing and mounted on the housing so as to be able to rotate about a first axis of rotation, the first reel comprising a first reel core, and further wherein the tape is wound around the first reel core with a section which comprises the first end,
wherein the cassette device comprises a second reel arranged in the interior space of the housing and mounted on the housing so as to be able to rotate about a second axis of rotation, the second reel comprising a second reel core to which is attached a section of the tape which comprises the second end,
wherein the tape is guided along a path from the first reel to the second reel, and
further wherein the cassette device comprises a guide unit arranged in the interior space of the housing and connected to the housing, the guide unit configured such that that the tape is guided in such a manner that a first section of the path is opposite the first opening and the first side of the tape faces the first opening in the first section.

30. The cassette device of claim 29, wherein the guide unit comprises a first deflection roller and a second deflection roller, wherein the first section of the path is between the first deflection roller and the second deflection roller.

31. The cassette device of claim 29, wherein a second opening is formed in the housing and connects the interior space of the housing to the external environment of the housing, wherein the guide unit is configured such that the tape is guided on the guide unit such that a second section of the path is opposite the second opening, wherein the first side of the tape faces the second opening in the second section of the path.

32. The cassette device of claim 29, wherein the cassette device comprises a data storage device having cassette device-related data capable of being acquired by a first acquisition unit of the base device.

33. A base device, comprising:
a base body having a second connecting device that is capable of being connected in a positive-locking and releasable manner to a first connecting device of a housing of a cassette device, and a third connecting device for connection to a manufacturing system; and
a deflection unit that comprises a free end and a deflection element attached to the free end, wherein the deflection unit is movably coupled to the base body in such a manner that the deflection unit can be moved between a retracted position and an extended position along a travel path, wherein, when the first connecting device and the second connecting device are Page: 7 connected in a positive-locking and releasable manner to one another, the deflection unit is arranged at least partially within an interior space of the housing, the deflection element is arranged on a second side of a tape which is opposite a first side of the tape and a first section of a path, and further wherein in the retracted position, the deflection element and the tape are arranged in the interior space, and in the extended position, a subsection of the tape is in contact with the deflection element, and the deflection element and at least the subsection of the tape which is in contact with the deflection element are arranged in an external environment of the housing.

34. The base device of claim 33, wherein the base device further comprises a cylinder; a piston that can be moved in the cylinder along an effective axis and that extends from one end along the effective axis to a second end; and a suction pad plunger attached to the second end of the piston, wherein, when the first connecting device of the housing of the cassette device and the second connecting device of the base body are connected in a positive-locking and releasable manner to one another, the effective axis is oriented such that the suction pad plunger can be moved along the effective axis such that the suction pad plunger can then be brought into contact with a punched part on the tape when the deflection unit is in the extended position.

35. The base device of claim 33, further comprising:
a clamping means arranged such that a second opening of the housing of the cassette device is arranged between the clamping means and a second section of the path when the first connecting device of the cassette device and the second connecting device of the base body are connected in a positive-locking and releasable manner to one another,
wherein a first opening is formed in the housing and connects the interior space of the housing to the external environment of the housing, and
further wherein the second opening is formed in the housing and connects the interior space of the housing to the external environment of the housing.

36. The base device of claim 33, further comprising:
a first actuator configured to drive a shaft in rotation about a shaft axis, wherein the shaft can be coupled to a second reel of the cassette device, which can rotate about a second axis of rotation, such that a rotation of the shaft about the shaft axis causes a rotation of the second reel about the second axis of rotation,
wherein the cassette device comprises a first reel arranged in the interior space of the housing and mounted on the housing so as to be able to rotate about a first axis of rotation, the first reel comprising a first reel core, and further wherein the tape is wound around the first reel core with a section which comprises the first end, and
further wherein the cassette device comprises the second reel arranged in the interior space of the housing and mounted on the housing so as to be able to rotate about the second axis of rotation, the second reel comprising a second reel core to which is attached a section of the tape which comprises the second end.

37. The base device of claim 36, further comprising:
a second actuator for moving the deflection unit between the retracted position and the extended position.

38. The base device of claim 33, further comprising:
a first acquisition unit configured to acquire cassette device-related data of a data storage device of the cassette device.

39. A robot device, comprising:
a frame;
a robotic arm having a first end and a second end; and
the base device of claim 33,
wherein the first end of the arm is attached to the frame, and
wherein the second end of the arm is attached to the third connecting device of the base device.

40. A manufacturing system, comprising:
the robot device of claim 39; and
a changing station,
wherein a plurality of the cassette devices of claim 29 are arranged in the changing station.
